(19) United States
(12) Patent Application Publication
(10) Pub. No.: US 2015/0063715 A1
(43) Pub. Date: Mar. 5, 2015

(54) METHOD FOR PROCESSING IMAGE AND ELECTRONIC DEVICE THEREOF

(71) Applicant: Samsung Electronics Co., Ltd., Suwon-si (KR)

(72) Inventors: Woo-Yong LEE, Hwaseong-si (KR); Dong-Kook PARK, Suwon-si (KR); Jae-Yun SONG, Seoul (KR)

(21) Appl. No.: 14/474,588

(22) Filed: Sep. 2, 2014

(30) Foreign Application Priority Data
Sep. 2, 2013 (KR) 10-2013-0105155

(51) Int. Cl. G06T 5/10

(52) U.S. Cl. CPC G06T 5/10; G06T 2207/20172; G06T 2207/20024
USPC 382/260

(57) ABSTRACT

An electronic device and a method for outputting an image in an electronic device are provided. The electronic device includes an image acquisition module configured to acquire an image to apply an effect, a first filter manager configured to manage generation of a first image corresponding to an effect, a second filter manager configured to manage generation of at least one second image corresponding to an effect of an image, and a graphic processor configured to generate the first image and the second image according to a request of the first filter manager and the second filter manager.

### CROSS-REFERENCE TO RELATED APPLICATION(S)

This application claims the benefit under 35 U.S.C. §119(a) of a Korean patent application filed on Sep. 2, 2013 in the Korean Intellectual Property Office and assigned Serial number 10-2013-0105155, the entire disclosure of which is hereby incorporated by reference.

### TECHNICAL FIELD

The present disclosure relates to a method for processing image and electronic device thereof

### BACKGROUND

Nowadays, electronic devices having a convergence function of complexly performing at least one function have gradually increased.

Moreover, as an electronic device, a mobile terminal, which may be referred to as a ‘smart phone’, is generally used. Particularly, such a mobile terminal has a display module of a large screen touch method and has a high pixel camera module, in addition to a basic function of communicating with another party, and thus can photograph a still picture and a moving picture. Further, the mobile terminal may reproduce multimedia contents such as music and a moving picture, and perform web surfing by connecting to a network. As such a mobile terminal may have a high performance processor, and the mobile terminal may be enhanced to more quickly perform various convergence functions and has remarkably developed so that a main function of communicating with another party is regarded as an additional function.

The electronic device may apply various photography effects to a photographed image or a stored image. According to an embodiment, the electronic device may process to apply an effect different from that of an original image using various filters.

Nowadays, by applying various photography effects to a photographed image or a stored image, an electronic device may process to apply an effect different from that of an original image.

The electronic device may output various images to which an effect is applied at a time point in which an input is detected in a state in which an application that can output an image is executed.

When the electronic device detects an input of an output of an image to which an effect is applied, the electronic device may output various images to which an effect is applied using a constituent element included in middleware.

When the electronic device detects an input that controls an image to which an output effect is applied, by providing the input that controls an image to middleware, the electronic device may perform an image control operation corresponding to the input.

As described above, when an image processing is concentrated on middleware, an image processing speed may be lowered.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to solve at least the above-mentioned problems and/or disadvantages and to provide at least the advantages described below. Accordingly, an aspect of the present disclosure is to provide a device and method for enhancing an image processing speed in an electronic device.

Another aspect of the present disclosure is to provide a device and method for distributing an image processing concentrated on middleware in an electronic device.

Another aspect of the present disclosure is to provide a device and method for applying an effect to a main image using middleware in an electronic device.

Another aspect of the present disclosure is to provide a device and method for applying an effect to a sub-image using an application in an electronic device.

In accordance with an aspect of the present disclosure, an electronic device is provided. The electronic device includes an image acquisition module configured to acquire an image to apply an effect, a first filter manager configured to manage generation of a first image corresponding to a first effect, a second filter manager configured to manage generation of at least one second image corresponding to a second effect of an image, and a graphic processor configured to generate the first image and the second image according to a request of the first filter manager and the second filter manager.

In accordance with another aspect of the present disclosure, a method of processing an image of an electronic device is provided. The method includes obtaining an image through an image sensor, generating a first image corresponding to a first effect of the image using a first filter manager, generating at least one second image corresponding to a second effect of the image using a second filter manager, and displaying the first image and the second image.

In accordance with another aspect of the present disclosure, a computer readable recording medium on which a program for executing an operation of obtaining an image through an image sensor, an operation of generating a first image corresponding to an effect of the image using a first filter manager, an operation of generating at least one second image corresponding to another effect of the image using a second filter manager, and an operation of displaying the first image and the second image are recorded is provided.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device according to an embodiment of the present disclosure;

FIG. 2 is a block diagram illustrating a configuration of a programming module according to an embodiment of the present disclosure;

FIG. 3 is a block diagram illustrating a configuration of a processor according to an embodiment of the present disclosure;

FIG. 4 is a block diagram illustrating a configuration of a graphic processor according to an embodiment of the present disclosure;

FIG. 5 is a flowchart illustrating an image output operation of an electronic device according to an embodiment of the present disclosure;

FIG. 6 is a flowchart illustrating operation of a first filter manager according to an embodiment of the present disclosure;

FIG. 7 is a flowchart illustrating operation of a second filter manager according to an embodiment of the present disclosure;

FIG. 8 is a flowchart illustrating an image processing operation of an electronic device according to an embodiment of the present disclosure;

FIG. 9 is a diagram illustrating operation of generating an effect image according to an embodiment of the present disclosure; and

FIG. 10 is a flowchart illustrating operation of an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, in the present disclosure, technology for improving an image processing performance will be described.

In the following description, an electronic device may include at least one of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), a Moving Picture Experts Group (MPEG) Audio Layer-3 (MP3) player, a mobile medical device, a camera, a wearable device, an electronic clock, a wrist watch, a refrigerator, an air-conditioner, a vacuum cleaner, an artificial intelligence robot, a television, a Digital Video Disk (DVD) player, an audio device, an oven, a microwave oven, a washing machine, an air cleaner, a medical device, e.g., a Magnetic Resonance Angiography (MRA) device, a Magnetic Resonance Imaging (MRI) device, a Computed Tomography (CT) device, a scanning machine, and an ultrasonic wave device, a navigation device, a Global Positioning System (GPS) receiver, an Event Data Recorder (EDR), a Flight Data Recorder (FDR), a set-top box, a television box, e.g., Samsung HomeSync™, an electronic dictionary, a vehicle infotainment device, an electronic equipment for ship, e.g., a navigation device for ship and gyro compass, avionics, a security device, a camcorder, game consoles, a portion of furniture and/or a building/structure including an electronic device, an electronic board, an electronic signature receiving device, and a projector.

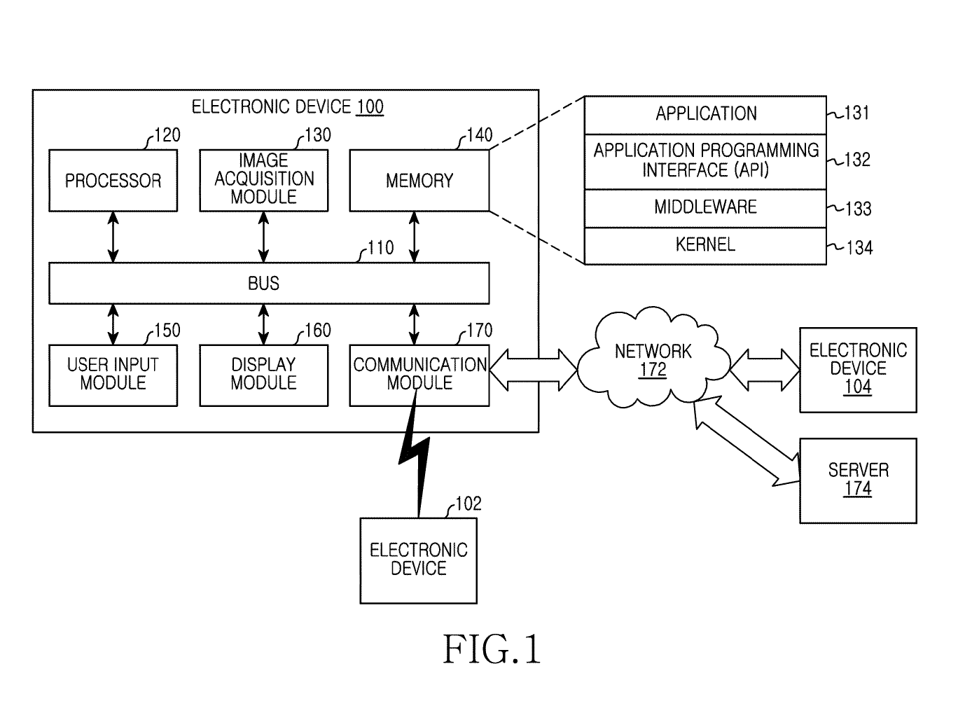

FIG. 1 is a block diagram illustrating a configuration of an electronic device according to an embodiment of the present disclosure.

Referring to FIG. 1, an electronic device 100 may include a bus 110, a processor 120, an image acquisition module 130, a memory 140, a user input module 150, a display module 160, and a communication module 170.

The bus 110 may connect constituent elements included in the electronic device 100 and control communication between constituent elements included in the electronic device 100.

The processor 120, which may be at least one of a hardware element, device, physical element, software element, and/or a combination thereof, may control the electronic device 100 to provide various services. For example, the processor 120 may decode an instruction received from at least one other constituent element, e.g., the image acquisition module 130, the memory 140, the user display module 150, the display module 160, and the communication module 170, included in the electronic device 100 through the bus 110 and may execute calculation and data processing according to the decoded instruction.

By executing at least one program stored at the memory 140, the processor 120 may control to provide various multimedia services. For example, by executing a first filter manager (not shown), included in middleware 133 of the memory 140, and a second filter manager (not shown), included in an application 131, the processor 120 may perform a pre-processing or a post-processing that applies an effect to an image acquired through the image acquisition module 130. According to an embodiment, the processor 120 may process to generate a main image to which an effect is applied through the first filter manager and a sub-image to which an effect is applied through the second filter manager. According to an embodiment, the main image may be an image output on a preview screen. According to an embodiment, the sub-image may be a list of a main image to which different kinds of effects are applied. According to an embodiment, the sub-image may be output into a thumbnail image.

The processor 120 may process to output a main manager generated through the first filter manager and a sub-image generated through the second filter manager into one image. According to an embodiment, the processor 120 may dispose a second image in at least a partial area of the first image.

The memory 140 may store an instruction and/or data received from at least one constituent element, such as the processor 120, the image acquisition module 130, the user input module 150, the display module 160, and the communication module 170, included in the electronic device 100 or generated by at least one constituent element. For example, the memory 140 may store a filter of an effect that may be applied to an image to which an effect is applied by an input, an acquired image, or a stored image.

The memory 140 may include programming modules such as a kernel 134, the middleware 133, an Application Programming Interface (API) 132, and the application 131. In this case, each programming module may include at least one of software, firmware, and hardware.

The kernel 134 may control or manage at least one system resource used for executing an operation or a function implemented by another programming module, e.g., the middleware 133, the API 132, or the application 131, included in the memory 140. Further, the kernel 134 may provide an interface that may control or manage by accessing to an individual constituent element of the electronic device 100 from at least one of the middleware 133, the API 132, and the application 131. Here, the system resource may include at least one of the bus 110, the processor 120, and the memory 140. According to an embodiment, the kernel 134 may include a driver (not shown), e.g., a camera driver, that controls operation of the image acquisition module 130.

The middleware 133 may perform an intermediary function of transmitting and receiving data by enabling the API 132 or the application 131 to communicate with the kernel 134. Further, the middleware 133 may perform load balancing of work requests received from at least one application 131.

The middleware 133 provides a function through the API 132 so that the application 131 efficiently uses a limited system resource within the electronic device 100. In order to provide a function in which the application 131 commonly requires, the middleware 133 may include a previously implemented plurality of modules. According to an embodiment, the middleware 133 may include a first filter manager for applying an effect to a main image.

The API 132 may include an interface in which the application 131 may control a function that is provided in the kernel 134 or the middleware 133. For example, the API 132 may include at least one interface or function, such as image acquisition, image processing, image storage, or image control.

The user input module 150 may transmit an instruction or data, occurring by a user selection, to the processor 120 or the memory 140 through the bus 110.

The display module 160 may display a picture, an image, or data to a user. According to an embodiment, the display module 160 may display at least one of a main image and a sub-image to which an effect is applied.

The communication unit 170 may connect communication between at least one another electronic device 102 or 104, a server 174, or at least one peripheral device and the electronic device 100. For example, the communication unit 170 may support a short range communication protocol, e.g., Wireless Fidelity (WiFi), Bluetooth (BT), and Near Field Communication (NFC), or communication of a network 172, e.g., Internet, a Local Area Network (LAN), a Wide Area Network (WAN), a telecommunication network, a cellular network, a satellite network, or a Plain Old Telephone Service (POTS). Here, the other electronic device 102 or 104 may include a device of the same type as that of the electronic device 100 or a device of a type different from that of the electronic device 100, such as a peripheral device of the electronic device 100.

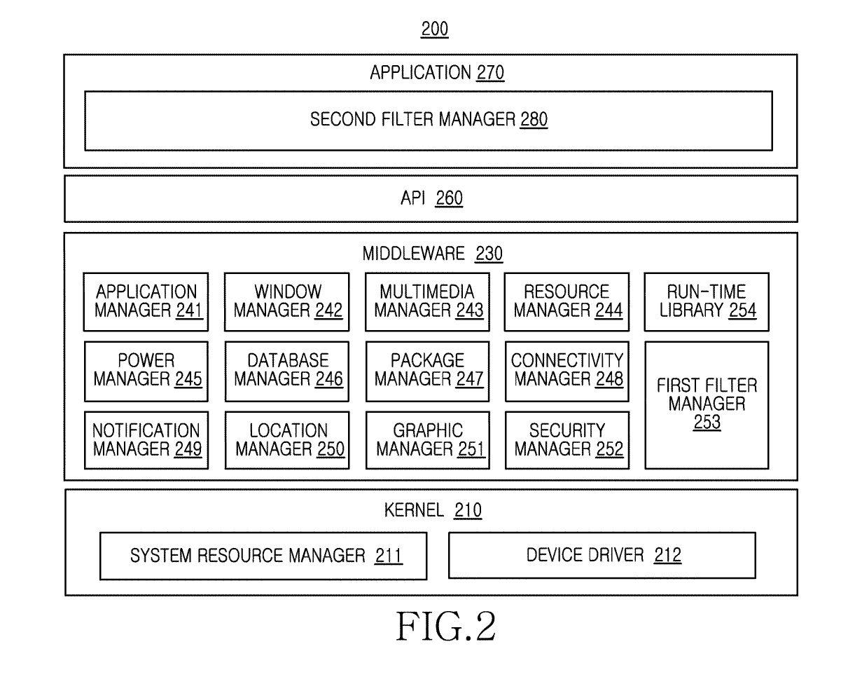

FIG. 2 is a block diagram illustrating a configuration of a programming module according to an embodiment of the present disclosure.

Referring to FIG. 2, a programming module 200 may include a kernel 210, middleware 230, an API 260, and an application 270. Here, the programming module 200 may be stored at the memory 140 of the electronic device 100 of FIG. 1.

The programming module 200 may include an Operation System (OS) that controls a resource related to the electronic device 100 or various applications 270 driven in the OS. For example, the OS may include at least one of Android, iOS, Windows, Symbian, Tizen, and Bada.

The kernel 210 may include at least one of a system resource manager 211 and a device driver 212.

The system resource manager 211 may control, allocate, or recover a system resource. For example, the system resource manager 211 may include at least one of a process management unit, a memory management unit, and a file system management unit.

The device driver 212 may perform an operation of controlling a system resource used for executing an operation or a function implemented by another constituent element, e.g., the middleware 230, the API 260, or the application 270, of the programming module 200. For example, the device driver 212 may include at least one of a display driver, a camera driver, a Bluetooth driver, a sharing memory driver, a Universal Serial Bus (USB) driver, a keypad driver, a wireless LAN driver, an audio driver, and an Inter-Process Communication (IPC) driver.

In order to provide a function which the application 270 commonly needs and/or uses, the middleware 230 may include a previously implemented plurality of modules. The middleware 230 may provide a function through the API 260 so that the application 270 efficiently uses a limited system resource within the electronic device. For example, the middleware 230 may include at least one of a run time library 254, an application manager 241, a window manager 242, a multimedia manager 243, a resource manager 244, a power manager 245, a database manager 246, a package manager 247, a connectivity manager 248, a notification manager 249, a location manager 250, a graphic manager 251, a security manager 252, and a first filter manager 253.

In order to add a new function through a programming language while the application 270 is being executed, the run time library 254 may include a library module which a compiler uses. For example, the run time library 254 may perform a function of an input and output, memory management, or an arithmetic function.

The application manager 241 may manage a life cycle of at least one of the application 270.

The window manager 242 may manage a Graphic User Interface (GUI) resource using on a screen.

The multimedia manager 243 may determine a format used for reproduction of various media files. Further, the multimedia manager 243 may encode or decode a media file using a codec corresponding to a format used for reproduction of media files.

The resource manager 244 may manage a resource of a source code, a memory, or a stored space of at least one application of the application 270.

The power manager 245 may manage a battery or power by operating together with a Basic Input/Output System (BIOS) and provide power information necessary for operation.

The database manager 246 may manage to generate, search for, or change a database to use in at least one application of the application 270.

The package manager 247 may manage installation or update of an application distributed in a format of a package file. According to an embodiment, the package manager 247 may install a filter received from a filter provider, such as a filter providing server, or may remove a previously installed filter.

The connectivity manager 248 may manage wireless connection of the electronic device 100.

The notification manager 249 may display or notify an event of a received message, appointment, and proximity notification with a method that does not disturb a user.

The location manager 250 may manage location information of the electronic device 100.

The graphic manager 251 may manage a graphic effect to be provided to a user or a user interface related thereto.

The security manager 252 may provide several security functions necessary for system security or user authentication.

When a request for applying an effect to an image is input from an application 270, the first filter manager 253 may acquire an image to apply the effect and process to generate a main image to which the effect is applied and a sub-image to which the effect is applied through the application. According to an embodiment, the first filter manager 253 may change a size of the acquired image to a previously defined size and provide the image to the application 270, thereby processing to generate a sub-image. The first filter manager 253 may load a filter and apply a plurality of effects to the acquired image. According to an embodiment, the first filter manager 253 may generate a main image to which an effect is applied based on an API, such as Open Graphics Library (OpenGL) and DirectX, and provide various kinds of filters that can give various effects to the main image.

The first filter manager 253 may include a filter directory, in which various kinds of filters of an effect that may apply to an image are formed into a group.

According to an embodiment, the first filter manager 253 may store a filter received through an external server at a filter directory. According to another embodiment, the first filter manager 253 may store a user defined filter in which a plurality of filters are combined into one at a filter directory. According to an embodiment, filters included in the filter directory may be commonly used by the first filter manager 253 and a second filter manager 280

When the electronic device provides a dedicated audio communication or audiovisual communication service, the middleware 230 may further include a telephony manager for managing the dedicated audio communication or audiovisual communication service of the electronic device.

The middleware 230 may generate and use a new middleware module through various function combinations of internal constituent element modules. In order to provide a distinguished function, the middleware 230 may provide a module specialized according to a kind of an OS. Further, the middleware 230 may dynamically delete some of existing constituent elements or may add a new constituent element. Therefore, some of constituent elements described in an embodiment of the present disclosure may be omitted, other constituent element may be further provided, or constituent elements described in an embodiment of the present disclosure may be replaced with constituent elements having other names and that performs similar functions.

The API 260 is a set of API programming functions and may be provided to another constituent element according to an OS.

The application 270 may include at least one of a preloaded application and a third party application.

The application 270 may include the second filter manager 280. When a request for applying an image effect is detected, the application 270 may process the middleware 230 to generate an image to which an effect is applied. The second filter manager 280 may apply an effect to an image received from the middleware 230. According to an embodiment, the second filter manager 280 may receive an original image or an image having an adjusted size from the first filter manager 253. According to an embodiment, the second filter manager 280 may adjust a size of an original image received from the first filter manager 253 to a previously defined size and apply an effect to the image having an adjusted size. According to an embodiment, the second filter manager 280 may load a filter stored at a filter directory and apply a plurality of effects to an acquired image. According to an embodiment, the second filter manager 280 may generate a main image to which an effect is applied based on an API, such as OpenGL and DirectX, and provide various kinds of filters that can give various effects to the main image.

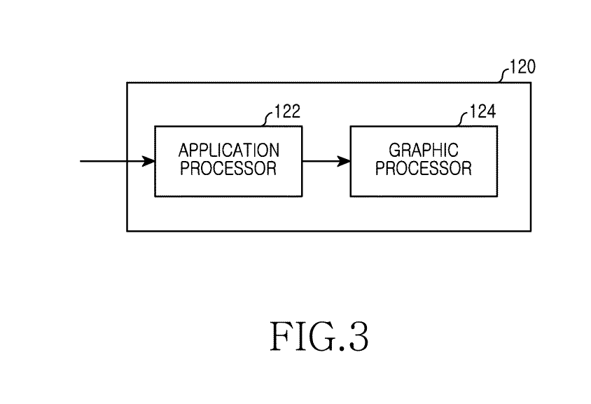

FIG. 3 is a block diagram illustrating a configuration of a processor according to an embodiment of the present disclosure.

Referring to FIG. 3, the processor 120 may include at least one of an Application Processor (AP) 122 and a Graphic Processing Unit (GPU) 124. The processor 120 may include at least one Communication Processor (CP) (not shown).

By driving an OS or an application program, the AP 122 may control a plurality of hardware or software components connected thereto and perform various data processing and calculation including multimedia data. The AP 122 may be implemented with, for example, a System on Chip (SoC).

According to an embodiment, when outputting an image, the AP 122 may process output images to which various kinds of effects are applied together. According to an embodiment, the AP 122 may load and process an instruction or data received from at least one of other constituent elements or a connected non-volatile memory at a volatile memory. Further, the AP 122 may store data received from at least one of the other constituent elements or generated by at least one of the other constituent elements at a non-volatile memory.

The graphic processor 124 may process to generate an image to which an effect is applied according to a request for applying an effect to the image. According to an embodiment, the graphic processor 124 may perform an image generation operation that applies an effect to an image stored at an internal memory or an external memory which the graphic processor 124 uses. According to an embodiment, the graphic processor 124 may generate a second image in which an effect is applied to an image stored at an internal memory which the graphic processor 124 uses. According to an embodiment, the graphic processor 124 may generate a first image in which an effect is applied to an image stored at an external memory which the graphic processor 124 uses. According to an embodiment, the graphic processor 124 may check an input type and generate a first image or a second image. According to an embodiment, the graphic processor 124 may detect an input that stores an image at an internal memory or an input of information of an external memory at which an image is stored.

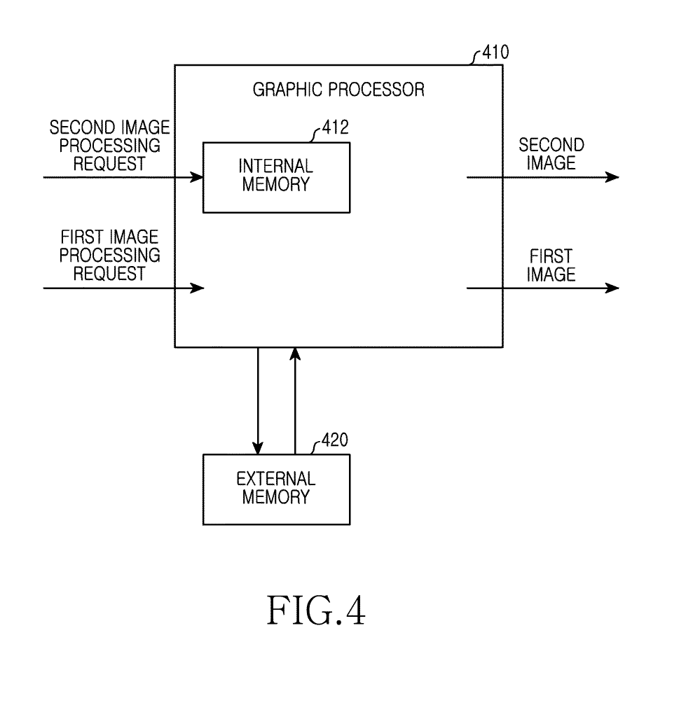

FIG. 4 is a block diagram illustrating a configuration of a graphic processor according to an embodiment of the present disclosure.

Referring to FIG. 4, a graphic processor 410 may be a graphic processor of FIG. 3. According to an embodiment, the graphic processor 410 may be a constituent element using an internal memory 412 and an external memory 420.

The graphic processor 410 may receive an image processing request, such as a generation request of an image to which an effect is applied, through a first filter manager and a second filter manager. According to an embodiment, an image processing request, e.g., a first image processing request, provided by the first filter manager may be a request for applying an effect to a main image. According to an embodiment, the main image may be preview data. According to an embodiment, an image processing request provided by the first filter manager together with an address of the external memory 420 that stores an image to which an effect is to be applied may be provided to the graphic processor 410.

An image processing request, e.g., second image processing request, provided by the second filter manager may be a request for applying an effect to a sub-image. According to an embodiment, in order to reduce an image processing load of preview data by the second filter manager, the sub-image may be a thumbnail image changed to a previously defined size. According to an embodiment, an image processing request provided by the second filter manager may be provided to the graphic processor 410 together with an image to which an effect is to be applied. According to an embodiment, an image to which an effect is to be applied may be copied to the internal memory 412 of the graphic processor 410 and be stored at the internal memory 412.

The graphic processor 410 may generate a main image and a sub-image to which an effect is applied according to an image processing request received from the first filter manager and the second filter manager.

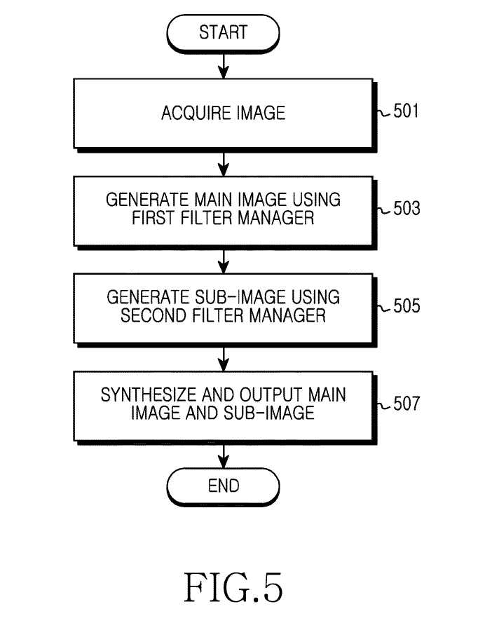

FIG. 5 is a flowchart illustrating an image output operation of an electronic device according to an embodiment of the present disclosure.

Referring to FIG. 5, the electronic device may acquire an image at operation 501. According to an embodiment, by executing an application that supports an image pre-processing and post-processing, such as an image viewer, an image edition program, a camera application, and a video phone application, the electronic device may acquire an image. According to an embodiment, by executing a camera application, the electronic device may acquire an image output on a preview screen.

The electronic device may generate a main image using a first filter manager at operation 503. According to an embodiment, the main image may be a preview image having a large size or quantity. According to another embodiment, by performing a filter work in a preview image having a large size or quantity, the main image may be an image to which a specific effect is applied.

The electronic device may generate a main image using a first filter manager included in middleware.

The electronic device may generate a sub-image using a second filter manager at operation 505. According to an embodiment, the sub-image may become a list of main images to which different kinds of effects are applied. According to an embodiment, the sub-image may include a thumbnail image adjusted to a previously defined size of a preview image.

The electronic device may generate a sub-image using a second filter manager included in an application.

The electronic device may synthesize and output a main image and a sub-image at operation 507.

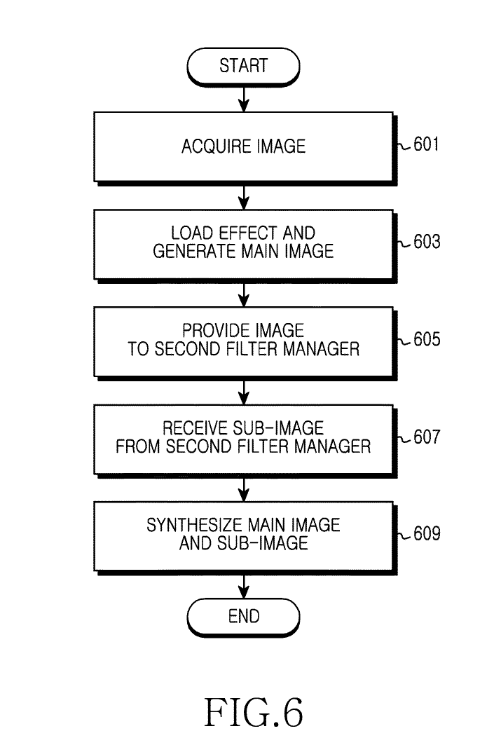

FIG. 6 is a flowchart illustrating operation of a first filter manager according to an embodiment of the present disclosure.

Referring to FIG. 6, the first filter manager may be at least one constituent element included in middleware.

The first filter manager may acquire an image at operation 601. According to an embodiment, the first filter manager may receive an image acquisition request through an application, provide the image acquisition request to a kernel, and acquire an image.

The first filter manager may load an effect and generate a main image at operation 603. According to an embodiment, the first filter manager may load an effect to apply to an image in a filter directory of the first filter manager.

The first filter manager may provide an image to the second filter manager at operation 605. According to an embodiment, the first filter manager may provide an image to the second filter manager included in a superordinate layer, e.g., an application. According to an embodiment, the first filter manager may adjust an acquired image original or original image to a previously defined size and provide the adjusted image original or original image to the second filter manager.

The first filter manager may receive a sub-image from the second filter manager at operation 607. According to an embodiment, the sub-image may be a list of main images to which different kinds of effects are applied.

The first filter may synthesize the main image and the sub-image and process to output two images together at operation 609.

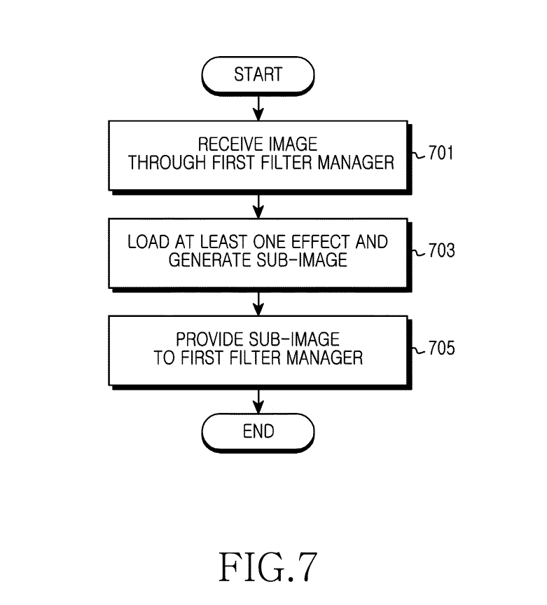

FIG. 7 is a flowchart illustrating operation of a second filter manager according to an embodiment of the present disclosure.

Referring to FIG. 7, the second filter manager may be a constituent element included in a layer higher than that of the first filter manager. According to an embodiment, the second filter manager may be included in an application.

The second filter manager may receive an image through the first filter manager at operation 701.

The second filter manager may load at least one effect and generate a sub-image at operation 703. According to an embodiment, the second filter manager may load an effect to apply to an image in a filter directory of the first filter manager. According to an embodiment, the second filter manager may receive an original image or an image adjusted to a previously defined size from the first filter manager. According to an embodiment, the second filter manager may generate a sub-image using an image received from the first filter manager or may adjust a size of the received image to a previously defined size and generate a sub-image using the image having an adjusted size.

The second filter manager may provide a sub-image, to which an effect is applied, to the first filter manager at operation 705.

According to various embodiments of the present disclosure, the second filter manager may be separated from the first filter manager to generate a sub-image.

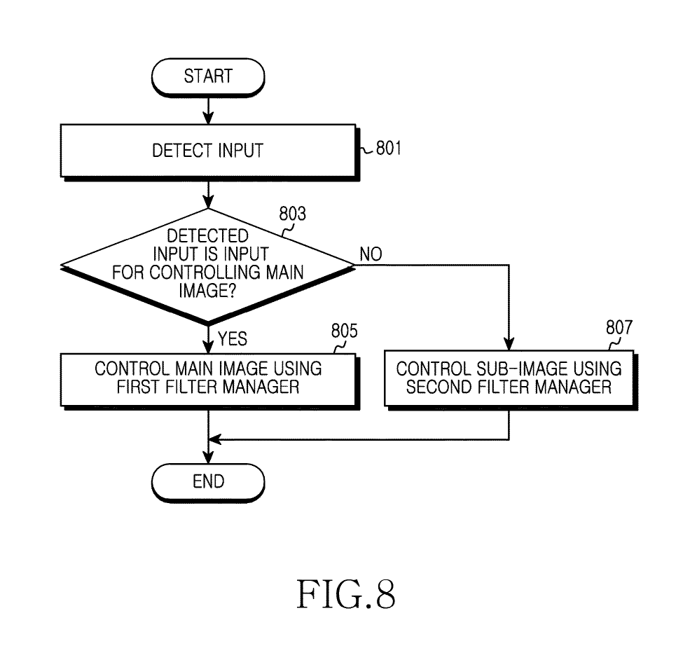

FIG. 8 is a flowchart illustrating an image processing operation of an electronic device according to an embodiment of the present disclosure.

Referring to FIG. 8, the electronic device may detect an input at operation 801.

The electronic device may determine whether the detected input is an input for controlling a main image at operation 803, and may determine whether the detected input is an input for controlling a sub-image at operation 803.

If the detected input is an input for controlling a main image, the electronic device may control a main image using the first filter manager at operation 805. According to an embodiment, the input for controlling a main image may include at least one of inputs that enlarge, reduce, and move an output main image. According to another embodiment, the input that outputs a main image may include an input that enables to output the output sub-image to the main image.

If the detected input is not an input for controlling the main image, wherein the detected input may be an input for controlling the sub-image, the electronic device may control a sub-image using the second filter manager at operation 807. According to an embodiment, the input for controlling a sub-image may be an input that enables to change a location of the output sub-image. According to an embodiment, an input that enables to change a location of the sub-image may include at least one of scroll, panning, and swipe inputs of the output sub-image.

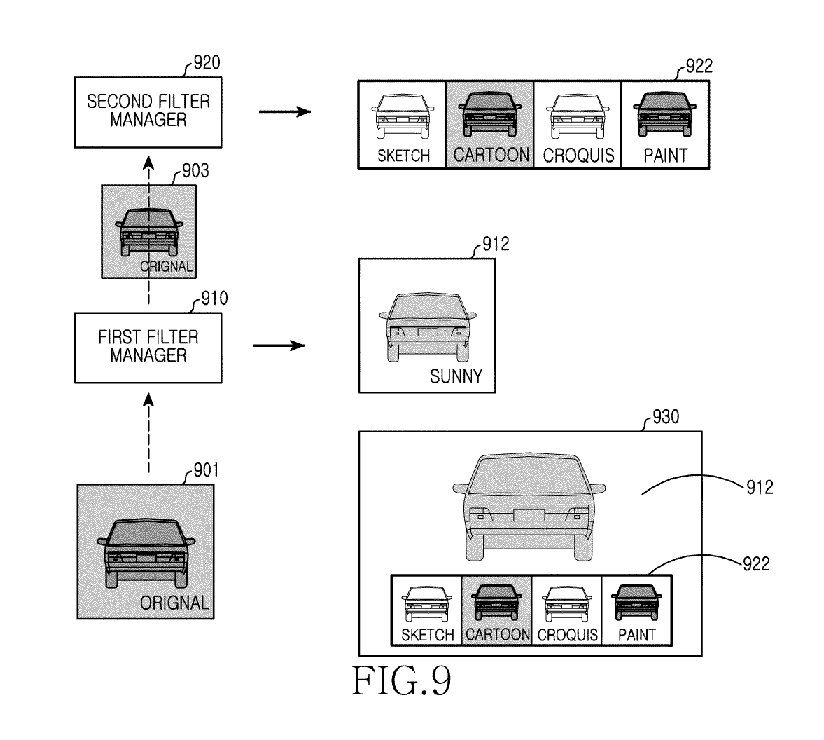

FIG. 9 is a diagram illustrating operation of generating an effect image according to an embodiment of the present disclosure.

Referring to FIG. 9, an effect image may be generated through a first filter manager 910 and a second filter manager 920. According to an embodiment, the first filter manager 910 may be included in middleware of a memory, and the second filter manager 920 may be included in an application of a memory. According to an embodiment, the second filter manager 920 may be a constituent element of a camera application.

The first filter manager 910 may generate a main image to which an effect is applied using an acquired image 901 and request the second filter manager 920 to generate a sub-image to which an effect is applied. According to an embodiment, the first filter manager 910 may perform operation of adjusting a size of an original image 901 and by providing an image 903, having an adjusted size, to the second filter manager 920, the first filter manager 910 may request to generate a sub-image. According to an embodiment, the first filter manager 910 may adjust a size of an original image to a previously defined size that can reduce an image processing load of the second filter manager 920. The first filter manager 910 may load a filter corresponding to an effect to apply from among previous stored filters and process to perform an image processing operation of an original image. As shown in FIG. 9, the first filter manager 910 may generate a main image 912 in which a sunny effect is applied to an original image.

The second filter manager 920 may generate a sub-image to which an effect is applied using an image received from the first filter manager 910. According to an embodiment, by loading a filter that can apply to the image, the second filter manager 920 may generate a plurality of sub-images to which different kinds of effects are applied. As shown in FIG. 9, the second filter manager 920 may generate sub-images 922 to which each of a sketch, a cartoon, a croquis, and a paint effects are respectively applied. According to an embodiment, the second filter manager 920 may receive an original image or an image having an adjusted size from the first filter manager 910. According to an embodiment, the second filter manager 920 may adjust a size of an image received from the first filter manager 910 and apply an effect to the image having an adjusted size.

In order to output the main image 912 to which an effect is applied and the sub-images 922 to which an effect is applied into one image 930, the first filter manager 910 may perform an image processing operation.

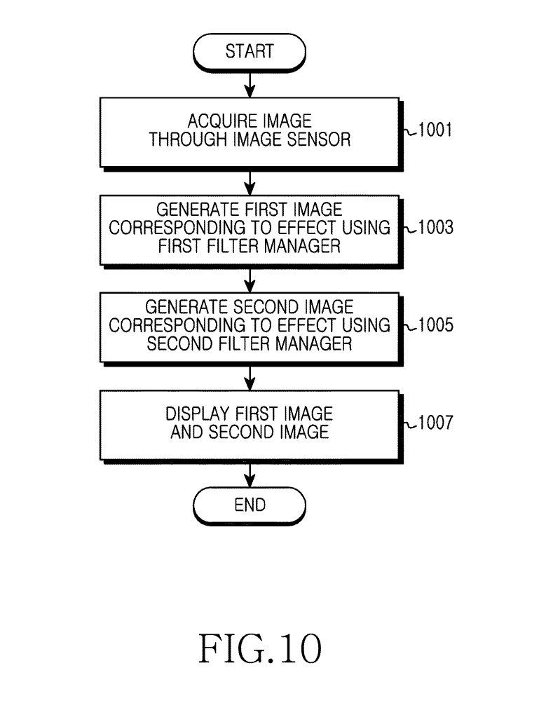

FIG. 10 is a flowchart illustrating operation of an electronic device according to an embodiment of the present disclosure.

Referring to FIG. 10, the electronic device may acquire an image through an image sensor at operation 1001.

The electronic device may generate a first image corresponding to an effect of the image using the first filter manager at operation 1003.

The electronic device may generate at least one second image corresponding to an effect of the image using the second filter manager at operation 1005.

The electronic device may display the first image and the second image at operation 1007.

An operation of displaying the first image and the second image may include an operation of displaying the second image in at least a partial area of the first image.

An operation of generating the second image may include an operation of receiving an image to which an effect is to be applied from the first filter manager.

An operation of generating the second image may include an operation of receiving an image adjusted to a previously defined size from the first filter manager.

An operation of generating a second image may include an operation of adjusting an image received from the first filter manager to a previously defined size.

A method of operating the electronic device may include providing a control input to the first filter manager when a control input of a first image is detected after displaying the first image and the second image.

A method of operating the electronic device may include providing a control input to the second filter manager when a control input of a second image is detected after displaying the first image and the second image.

Operation of generating the first image and the second image may include applying an effect by commonly using one filter directory.

Each of the foregoing constituent elements of an electronic device, according to an embodiment of the present disclosure, may be formed with at least one component, and a name of a corresponding constituent element may be changed according to a kind of an electronic device. An electronic device according to an embodiment of the present disclosure may include at least one of the foregoing constituent elements, and some constituent element may be omitted or additional other constituent elements may be further included. Further, as some of constituent elements of an electronic device according to an embodiment of the present disclosure are formed in one entity by coupling, a function of corresponding constituent elements before coupling may be equally performed.

A constituent element, for example, a “module” used for the present disclosure may be a unit including a combination of at least one of, for example, hardware, software, or firmware. The “module” may be interchangeably used with a term such as a unit, logic, a logical block, a component, or a circuit. The “module” may be a minimum unit or a portion of an integrally formed component. The “module” may be a minimum unit or a portion that performs at least one function. The “module” may be mechanically or electronically implemented. For example, a “module” according to an embodiment of the present disclosure may include at least one of an Application-Specific Integrated Circuit (ASIC) chip, Field-Programmable Gate Arrays (FPGAs), or a programmable-logic device that performs any operation known or to be developed.

According to various embodiments, at least a portion of a method, e.g., operations, or a device, e.g., modules or functions thereof, according to the present disclosure may be implemented with an instruction stored at computer-readable storage media in a form of, for example, a programming module. When the instruction is executed by at least one processor, the at least one processor may perform a function corresponding to the instruction. The computer-readable storage media may be, for example, a memory. At least a portion of the programming module may be implemented by, for example, the processor. At least a portion of the programming module may include, for example, a module, a program, a routine, sets of instructions, or a process for performing at least one function.

The computer-readable storage media may include magnetic media, such as a hard disk, a floppy disk, and a magnetic tape, optical media, such as a Compact Disc Read Only Memory (CD-ROM) and a Digital Versatile Disc (DVD), magneto-optical media, such as a floptical disk, and a hardware device formed to store and perform a program instruction, e.g., a programming module, such as a Read Only Memory (ROM), a Random Access Memory (RAM), and a flash memory. Further, a program instruction may include a high-level language code that may be executed by a computer using an interpreter, as well as a machine language code generated by a compiler. In order to perform operations of the present disclosure, the above-described hardware device may be formed to operate as at least one software module, and vice versa.

A module or a programming module according to the present disclosure may include at least one of the foregoing constituent elements, may omit some constituent elements, or may further include additional other constituent elements. Operations performed by a module, a programming module, or another constituent element according to the present disclosure may be executed with a sequential, parallel, repeated, or heuristic method. Further, some operations may be executed in different orders, may be omitted, or may add other operations.

According to various embodiments, in a storage medium that stores instructions, when the instructions are executed by at least one processor, the instructions are sent to at least one processor to perform at least one operation, and the at least one operation may include an operation of obtaining an image through an image sensor, an operation of generating a first image corresponding to an effect of the image using a first filter manager, an operation of generating at least one second image corresponding to an effect of the image using a second filter manager, and an operation of displaying the first image and the second image.

According to various embodiments of the present disclosure, by distributing a processing operation that applies various effects to image data obtained from an image sensor, an image processing performance can be enhanced.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
an image acquisition module configured to acquire an image to apply an effect;
a first filter manager configured to manage generation of a first image corresponding to a first effect using the acquired image;
a second filter manager configured to manage generation of at least one second image corresponding to a second effect; and
a graphic processor configured to generate the first image and the second image according to a request of the first filter manager and the second filter manager.

2. The electronic device of claim 1, wherein the first filter manager is further configured to output the first image and the second image generated by the graphic processor as one image.

3. The electronic device of claim 1, wherein the second filter manager is further configured to receive an image to which an effect is to be applied from the first filter manager and to process to store the image at an internal memory which the graphic processor uses.

4. The electronic device of claim 1, wherein the first filter manager is further configured to acquire the image to which an effect is to be applied and to process to store the image at an external memory which the graphic processor uses.

5. The electronic device of claim 1, wherein the first filter manager comprises a filter directory comprising at least one filter corresponding to an effect to apply to an image, and
wherein any of the first filter manager and the second filter manager are further configured to respectively load a filter of the filter directory and to apply an effect to an image.

6. The electronic device of claim 5, wherein the first filter manager is further configured to store a user defined filter formed by combining at least two filters selected by an input at a filter directory.

7. The electronic device of claim 1, wherein the first filter manager is formed with at least one module included in middleware of a memory.

8. The electronic device of claim 1, wherein the second filter manager is formed with at least one module included in an application of a memory.

9. The electronic device of claim 2, wherein the second filter manager is further configured to control a second image output by detecting an input.

10. The electronic device of claim 9, wherein the second filter manager is further configured to control a second image output to correspond to at least one input of a scroll, a panning, and a swipe.

11. The electronic device of claim 1, wherein the second filter manager is further configured to generate sub-images to which each of a sketch, a cartoon, a croquis, and a paint effects are respectively applied.

12. A method in an electronic device comprising:
obtaining an image through an image sensor;
generating a first image corresponding to a first effect of the image using a first filter manager;
generating at least one second image corresponding to a second effect of the image using a second filter manager; and
displaying the first image and the second image.

13. The method of claim 12, wherein the displaying of the first image and the second image comprises displaying a second image in at least a partial area of the first image.

14. The method of claim 12, wherein the generating of the at least one second image comprises receiving an image in which an effect is to be applied from the first filter manager.

15. The method of claim 14, wherein the generating of the at least one second image comprises receiving an image adjusted to a previously defined size from the first filter manager.

16. The method of claim 14, wherein the generating of the at least one second image comprises adjusting a size of an image received from the first filter manager to a previously defined size.

17. The method of claim 12, further comprising providing a control input to the first filter manager, when a control input of the first image is detected after the first image and the second image are displayed.

18. The method of claim 12, further comprising providing a control input to the second filter manager, when a control input of the first image is detected after the first image and the second image are displayed.

19. The method of claim 12, wherein the generating of the first image and the second image comprises applying an effect by commonly using one filter directory.

20. The method of claim 12, further comprising generating sub-images to which each of a sketch, a cartoon, a croquis, and a paint effects are respectively applied by the second filter manager.

21. A non-transitory computer readable recording medium on which a program for executing an operation of obtaining an image through an image sensor, an operation of generating a first image corresponding to an effect of the image using a first filter manager, an operation of generating at least one second image corresponding to another effect of the image using a second filter manager, and an operation of displaying the first image and the second image are recorded.

22. The non-transitory computer readable recording medium of claim 21, wherein a program that generates the first image through the first filter manager included in middleware and that generates the second image through the second filter manager included in an application is recorded on the non-transitory computer readable recording medium.
